(19) United States
(12) Patent Application Publication
(10) Pub. No.: US 2014/0196015 A1
(43) Pub. Date: Jul. 10, 2014

(54) DECLARATION OF LIFETIME OF RESOURCE REFERENCE

(71) Applicant: MICROSOFT CORPORATION, Redmond, WA (US)

(72) Inventors: Jared Porter Parsons, Kirkland, WA (US); John J. Duffy, Seattle, WA (US); G. Shon Katzenberger, Fall City, WA (US); Alexander Daniel Bromfield, Seattle, WA (US); Yevgeniy Rozenfeld, Redmond, WA (US)

(73) Assignee: MICROSOFT CORPORATION, Redmond, WA (US)

(21) Appl. No.: 13/734,762

(22) Filed: Jan. 4, 2013

(51) Int. Cl. G06F 9/45

(52) U.S. Cl. CPC G06F 8/41
USPC 717/140

(57) ABSTRACT

A language extension that advances safety in system programming by specifying a lifetime of a reference that represents a resource. In accordance with the language extension, the lifetime references a particular scope in a manner that the compiler generates computer-executable instructions that enforce the lifetime of the reference to be a function of (e.g., no longer than) the lifetime of the particular scope. Accordingly, the resource lifetime may be specified in advance to have a particular scope. This helps in performing resource management as typical managed language programs can allow resources to exist indefinitely. Furthermore, because the resources have a defined finite lifetime, they might be more conveniently allocated on a stack, instead of on a heap, for much more efficient processing.

### BACKGROUND

Computing systems obtain a high degree of functionality by executing software programs. Programs consist of computer-executable instructions that are kept in some persistent form, such as on a harddrive, a compact disk, a thumbdrive, flash memory, or the like. During execution, such computer-executable instructions may often be loaded in random access memory, and executed by one or more processors of the computing system, causing the computing system to perform tasks.

In object-oriented programming, these computer-executable instructions are organized into objects that interact through function calls, and that may have one or more properties. Managed code is code that runs in a managed environment that provides type safety, but may also provide memory management and exception handling. In managed code, objects have unbounded lifetimes, no restriction on storage, and methods of access restriction involve indirection or extra resources.

Systems level programming is based upon tight and efficient management of access to and lifetime of resources (such as objects) throughout the system. One common way to provide this tight management is to use an Application Program Interface (API) to manage the lifetime and access of the resource.

### BRIEF SUMMARY

At least some embodiments described herein relate to a language extension that advances safety in system programming by specifying a lifetime of a reference that represents a resource. In accordance with the language extension, the lifetime references a particular scope in a manner that the compiler generates computer-executable instructions that enforce the lifetime of the reference to be a function of (e.g., no longer than) the lifetime of the particular scope. Accordingly, the resource lifetime may be specified in advance to have a particular scope. This helps in performing resource management as typical managed language programs can allow resources to exist indefinitely. Furthermore, because the resources have a defined finite lifetime, they might be more conveniently allocated on a stack, instead of on a heap, for much more efficient processing.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 abstractly illustrates a computing system in which some embodiments described herein may be employed;

FIG. 2 illustrates a system in which embodiments described herein may be employed including a type definition generation component, a type definition access component, and a compilation component;

FIG. 3 illustrates a flowchart of a method for declaring that a particular reference in a software program has a finite lifetime; and

FIG. 4 illustrates a flowchart of a method for compiling the computer program having the annotation.

### DETAILED DESCRIPTION

In accordance with embodiments described herein, a language extension is described that advances safety in system programming by specifying a lifetime of a reference that represents a resource. In accordance with the language extension, the lifetime references a particular scope in a manner that the compiler generates computer-executable instructions that enforce the lifetime of the reference to be a function of (e.g., no longer than) the lifetime of the particular scope. Accordingly, the resource lifetime may be specified in advance to have a particular scope. This helps in performing resource management as typical managed language programs can allow resources to exist indefinitely. Furthermore, because the resources have a defined finite lifetime, they might be more conveniently allocated on a stack, instead of on a heap, for much more efficient processing.

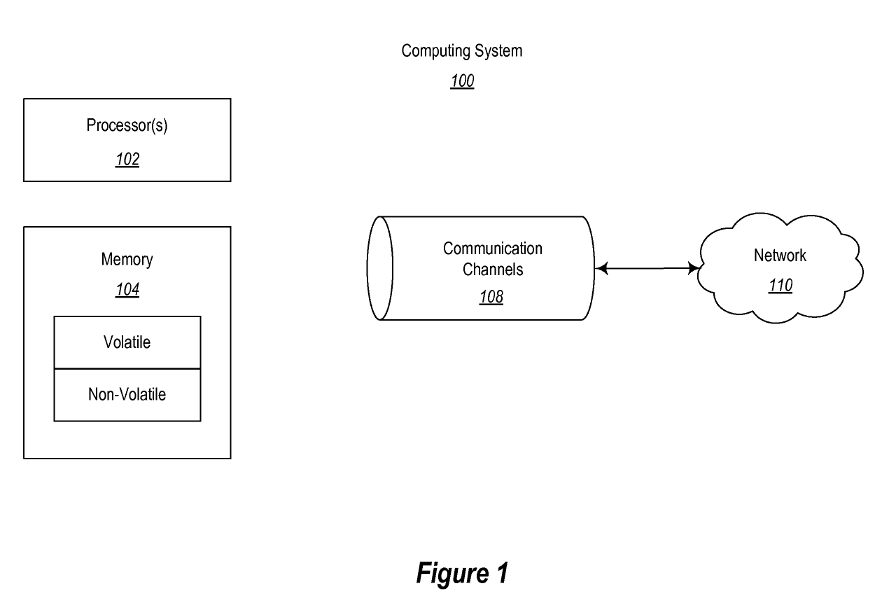

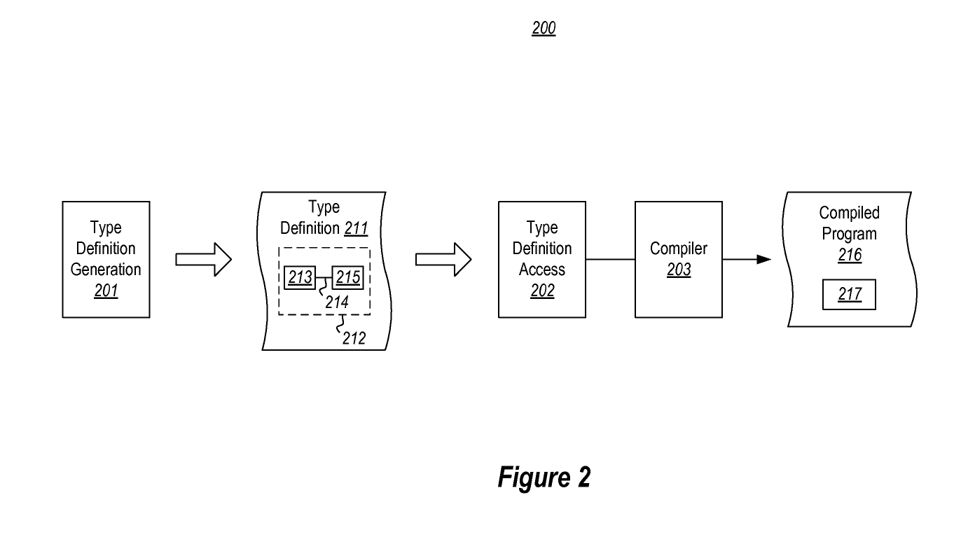

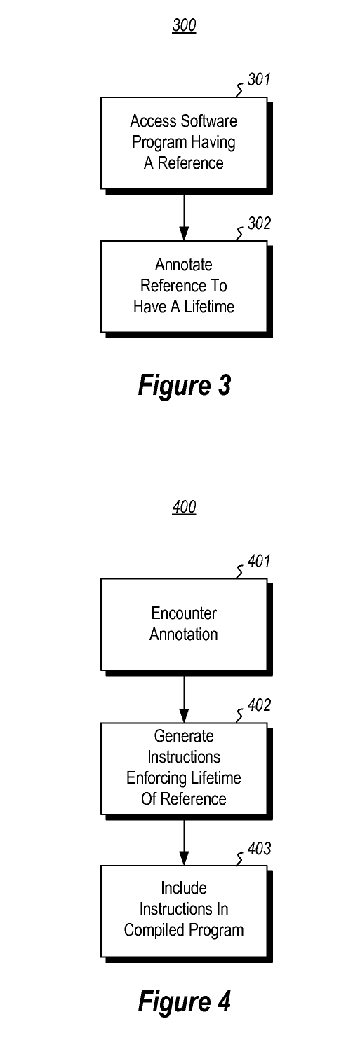

Some introductory discussion of a computing system will be described with respect to FIG. 1. Then, the principles of a managed code system will be described with respect to FIG. 2. Finally, the principles of the language extension to define reference lifetimes will be described with respect to FIGS. 3 and 4.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

A major challenge in system programming is controlling access to resources. In object-oriented programming resources are exposed as objects. For efficient resource usage and memory allocation, it is important that resources do not live longer than intended by the code which owns the resource. Often, resources are provided for what is intended to be a finite duration of usage. However, in managed programming there is nothing stopping a component from storing away a resource indefinitely and hence arbitrarily extend its usage. For instance, the resource can be wrapped in such a way that the owner revokes useful access to the resource, but this at best leads to a runtime failure in the system. The principles described herein solve this problem by providing lifetime semantics into the type system and enforcing the restrictions at compile time.

A scoped reference is a value which limits the access of a reference to a particular scope. A scope is a method for assigning a lifetime to a concept like an object, code block or stack frame. A scoped reference can be associated with a scope that has a lifetime that is provably shorter than the item that owns the reference, but is not associated with a scope that is longer than the item that owns the reference. By managing these scopes, a guarantee that a scoped reference never lives beyond a certain point in the system may be obtained.

FIG. 2 illustrates a system 200 that includes a type definition generation component 201, a type definition access component 202, and compilation component 203.

The type definition generation component 201 generates a type definition 211 that includes a scoped reference 212 that includes a reference 213 that is associated 214 with a particular scope 215. As an example, the type definition generation component 201 might be a component of authoring software, or might be a component of software that automatically generates code, such as source code, intermediate code, or machine code. The association 214 might be, for example, the annotation of the scope 215 to the reference 213. The scope 215 does not define access privileges for the reference 212, but does define a lifetime of the reference 212 that will be enforced by the compiler 203.

FIG. 3 illustrates a flowchart of a method 300 for declaring that a particular reference in a software program has a finite lifetime. The method 300 may be performed by the type definition generation component 201 of FIG. 2. The method includes accessing a software program under construction that includes a reference that defines a resource (act 301). The software program may be, for example, source code or perhaps even intermediate code. A reference in the software program (e.g., reference 213) is then annotated to be associated with a particular scope 215 having a finite lifetime (act 302). Again, the annotation is structured such that the compiler enforces a lifetime of the reference to be a function of the lifetime of the particular scope. For instance, the annotation may be structured such that the compiler enforces the lifetime of the reference to be no longer than the lifetime of the particular scope. Alternatively, the annotation may be structured such that the compiler enforces the lifetime of the reference to be shorter than the lifetime of the particular scope.

Referring again to FIG. 2, a type definition access component 202 accesses the type definition 211 that includes the scoped reference 212. A compilation component 203 responds to the scoped reference 212 by formulating computer-executable instructions 217 that cause a lifetime of the reference 213 to be a function of the lifetime of the particular scope 215; and includes the formulated computer-executable instructions 217 as part of the compiled computer program 217.

FIG. 4 illustrates a flowchart of a method 400 for compiling the computer program having the annotation. The method may be performed by, for example, the compilation component 203 of FIG. 2. Upon encountering the annotation in the computer program being compiled (act 401), the compilation component formulates computer-executable instructions (e.g., instructions 217) that cause a lifetime of the reference to be a function of the lifetime of the particular scope (act 402). For instance, such instructions might cause a lifetime of the reference to be no longer than a lifetime of the particular scope, or perhaps might cause a lifetime of the reference not be shorter than a lifetime of the particular scope. The compiler includes the computer-executable instructions as part of the compiled computer program (act 403). For instance, instructions 217 are included as part of the compiled program 216 of FIG. 2.

There are three types of scopes that will be described herein by way of example only. These three types will now be described in order, the first being referred to herein as a “lexical scope”, the second being referred to as a “stack frame scope”, and the third being referred to as an “object relational scope”. However, the broader principles are not limited to these particular scopes as the principles may apply to the tying of a reference lifetime to a lifetime of any other reference that has a finite lifetime.

The first kind is a lexical scope. This uses the C# notion of a block as a scope. Any given block is younger than the block in which it is nested and scoped references can be assigned into inner blocks. Any attempt to assign a reference outside of the defining block results in a compiler error. Consider the following pseudo-code example:

```
scoped Widget outer;
if (condition) {
    scoped Widget inner = outer; //ok
    ...
}
outer = inner; // error
```

There are two rules to consider. The above example illustrates one rule in that every scoped reference is associated with a scope, and references in a younger scope may not be used as if they were references in an older scope. In this example, the first assigned “scoped Widget inner=outer” is a proper assignment, since the variable “outer” is associated with an older scope than the scoped reference that it is assigned to in this assignment. Consider further the following pseudo-code example

```
scoped Widget outer;
if (condition) {
    Widget inner = outer; //error
    ...
}
```

This example illustrates a second rule in that a reference may also be unscoped. Unscoped references are not associated with a scope, regardless of where they lexically occur in a program's text. Another way to think of unscoped is as the biggest possible scope. Therefore, unscoped references may be used as if they were scoped references, but not vice versa. In this example, the assignment of “Widget inner=outer” is not permitted, even though “inner” is in an unscoped variable. This is because the variable “inner” is an unscoped variable, while the variable “outer” is a scoped variable. Thus, in this example, a scoped variable “outer” is attempted to be used as though it was an unscoped variable, which is not permitted.

The second kind of scope region deals strictly with object lifetime, and is referred to herein as “stack frame scope”. This often lines up very closely with lexical scope but is tracking a different idea. Every stack frame represents a different scope with newer frames being younger than the ones that precede them. There is also the heap region which is older than every stack region. This scope tracking ensures that objects allocated on a given stack frame will never be stored into a frame which will outlive the frame in which they were allocated.

The third kind of scoped region is the object relational scope. This allows a reference to be scoped to a particular object instance. The resulting reference can live no longer than the object to which it is related. This is can be done even when the scoped region of the particular reference is unknown. For instance, consider the following pseudo-code example:

```
class Container
{
  scoped(this) object m_field;
  public scoped(this) object GetField( )
  {
  return m_field;
  }
}
```

In this example the value returned from GetField will be defined in the same scope as the object on which GetField was called. If the object has no scope associated with it, then the access to the returned value will likewise be unbounded.

In order to consume scoped values, a method will mark its parameters or this value as scoped. This restricts the usage of the parameter or “this” to the minimum lifetime of all of the non-scoped input values.

Besides control over resources, another advantage scoped references provide is the ability to efficiently allocate objects on the stack instead of the heap. Typically, a managed object will do the majority of its object allocations on the heap and let the garbage collector later collect the memory when it is no longer in use. This is often unacceptable in system programming where allocations are closely monitored and heap allocations are often forbidden. Scoped references allow us to guarantee an object is not referenced beyond a certain point in a program and the need to store into the heap is removed. Consider the following pseudo-code:

```
{
  scoped Widget widget = new Widget( );
  ...
}
```

In this example, the Widget instance was allocated into a scoped reference location. This confines the use of the Widget value to the lexical scope containing the local named “widget”. Upon exiting the scope, the value is guaranteed to be unaliased in the system and can be collected immediately. This allows us to safely execute this allocation on the stack and avoid unnecessary heap pollution. This mechanism also allows us to allocate lambdas and their associated closure objects verifiably on the stack.

As stated previously, certain types in the system exist solely for resource management. They are intended to only be used in a scoped fashion and to do otherwise would constitute an invalid use of the resource. A cleanup routine is also commonly associated with these types (freeing a handle). This construct is formalized as a scoped type which has the following properties: 1) a scoped type can only be allocated into a scoped reference or a field of a scoped type, and 2) a scoped type can define a cleanup function which will be executed just before the value is out of scope. Additionally, because they are always used in a scoped fashion, a scoped type can always be allocated on the stack.

Accordingly, a mechanism for efficient and effective enforcement of a lifetime on a reference is described. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A computer-implemented method for declaring that a particular reference in a software program has a finite lifetime, the method comprising:
an act of accessing a software program under construction that includes a reference that defines a resource; and
an act of annotating a reference of the software program to be associated with a particular scope having a finite lifetime,
wherein the annotation is structured such that the compiler enforces a lifetime of the reference to be a function of the lifetime of the particular scope.

2. The method in accordance with claim 1, wherein the annotation is structured such that the compiler enforces the lifetime of the reference to be no longer than the lifetime of the particular scope.

3. The method in accordance with claim 1, wherein the particular scope is a lexical scope.

4. The method in accordance with claim 1, wherein the particular scope is a stack frame scope.

5. The method in accordance with claim 1, wherein the particular scope is an object relational scope.

6. The method in accordance with claim 1, wherein the software program is source code.

7. The method in accordance with claim 1, wherein the software program is intermediate code.

8. A computer program product comprising one or more computer-readable storage media having thereon computer-executable instructions that are structured, such that, when executed by one or more processors of a computing system, cause the computing system to execute a compiler that is configured to perform the following upon encountering an annotation in a computer program, the annotation associating the reference with a particular scope:
an act of formulating computer-executable instructions that cause a lifetime of the reference to be a function of the lifetime of the particular scope; and
including the formulated computer-executable instructions as part of the compiled computer program.

9. The computer program product in accordance with claim 8, wherein the computer-executable instructions cause a lifetime of the reference to be no longer than a lifetime of the particular scope.

10. The computer program product in accordance with claim 9, wherein the computer-executable instructions cause a lifetime of the reference not be shorter than a lifetime of the particular scope.

11. The computer program product in accordance with claim 9, wherein the particular scope is a lexical scope.

12. The computer program product in accordance with claim 9, wherein the particular scope is a stack frame scope.

13. The computer program product in accordance with claim 9, wherein the particular scope is an object relational scope.

14. The computer program product in accordance with claim 8, wherein the particular scope is a lexical scope.

15. The computer program product in accordance with claim 8, wherein the particular scope is a stack frame scope.

16. The computer program product in accordance with claim 8, wherein the particular scope is an object relational scope.

17. A system comprising:
a type definition access component that accesses a type definition of a particular type, the type definition including an annotation associating a reference with a particular scope; and
a compilation component that responds to the annotation by formulating computer-executable instructions that cause a lifetime of the reference to be a function of the lifetime of the particular scope; and includes the formulated computer-executable instructions as part of the compiled computer program.

18. The system in accordance with claim 17, wherein the particular scope is a lexical scope.

19. The system in accordance with claim 17, wherein the particular scope is a stack frame scope.

20. The system in accordance with claim 17, wherein the particular scope is an object relational scope.
